(19) United States
(12) Patent Application Publication
(10) Pub. No.: US 2024/0138375 A1
(43) Pub. Date: May 2, 2024

(54) PET EXCREMENT STORAGE DEVICE

(71) Applicant: Duk Hee KIM, Asan-si (KR)

(72) Inventor: Duk Hee KIM, Asan-si (KR)

(21) Appl. No.: 18/278,572

(22) PCT Filed: Feb. 21, 2022
(86) PCT No.: PCT/KR2022/002542

§ 371 Date: Aug. 23, 2023

(30) Foreign Application Priority Data
Feb. 23, 2021 (KR) 10-2021-0024143

(51) Int. Cl. A01K 23/00; B65F 1/06

(52) U.S. Cl. CPC A01K 23/005; B65F 1/06

(57) ABSTRACT

The present invention provides a pet excrement storage device for easily receiving and sealing the excrement of a pet. To this end, a pet excrement storage device comprises: a housing having an open upper part; a separation wall which has a plate-shape and is installed in the inner space of the housing; a vinyl holder which includes central shaft storage parts protruding upward from opposite side surfaces thereof; a rotating body from which a center shaft rotatably received; a cover enclosing all open parts of the housing, and having an open portion; and a pet excrement processing device separably coupled to the rotating body and opening/closing the open portion of the cover.

### TECHNICAL FIELD

The present disclosure relates to a pet excrement storage apparatus, and more particularly, to a pet excrement storage apparatus that easily accommodates therein, and seals excrement of a pet separated from sand.

### BACKGROUND ART

In general, pets raised indoors, especially cats, have a habit of digging soil or sand and covering their feces with soil or sand again. Thus, people raising cats indoors use an excrement device for cats in a form of a container filled with sand.

Such an excrement device for cats usually includes sand, an excrement container with an upper opening through which the inside of the container is filled with sand, and a shovel-shaped excrement disposal device that collects the excrement of the excrement container together with sand and filters out the excrement.

In this regard, the sand includes natural sand, an absorption type sand that absorbs moisture by itself, and a coagulation type sand that absorbs moisture and hardens. The absorption type sand includes silica gel, zeolite, etc. The coagulation type sand includes bentonite or pellets made of wood or pulp.

When the sand is thrown away every time the cat defecates or is replaced every 1 or 2 weeks, the amount of the sand as the garbage increases and it is difficult to dispose the same as the garbage. The excrement disposal device is required to filter out only the excrement of the cat buried in the sand filled in the excrement container.

An example of the prior art for solving this problem is disclosed in Korean Patent No. 10-1643879. Briefly describing the same, a sieve-type excrement disposal device is installed in the excrement container to filter out the excrement of the pet from the sand.

However, in the above prior art document, a separate device for disposing the filtered pet excrement has not been disclosed.

Therefore, the excrement of the cat compared to the other pets gives a very unpleasant stimulus to people's sense of odor. Thus, when the excrement of the cat is collected in a generally unsealed trash container, the odor of the cat's excrement remains indoors and interferes with the quality of life.

### DISCLOSURE

### Technical Problem

A purpose of the present disclosure is to provide a pet excrement storage apparatus that may neatly store therein the pet excrement filtered out by an excrement disposal device without spilling the same.

Another purpose of the present disclosure is to provide a pet excrement storage apparatus in which a odor of the stored pet excrement therein is sealed.

Still another purpose of the present disclosure is to provide a pet excrement storage apparatus capable of mounting a pet excrement disposal device therein.

The purpose of the present disclosure is not limited to the purpose as mentioned above, and other purposes not mentioned will be clearly understood by those skilled in the art from the descriptions below.

### Technical Solution

In order to achieve the purpose as described in above, a pet excrement storage apparatus according to one embodiment of the present disclosure includes a housing having an inner space defined therein and having an open top; a partitioning wall installed in the inner space of the housing and formed in a plate shape to divide the inner space into two spaces, wherein an upper portion of the plate shape is bent to seal a top of one of the two spaces, wherein a portion of a bottom of the plate shape is opened to form a vinyl bag feeding hole; a vinyl bag holder installed to surround a portion of the open top of the housing not sealed with the partitioning wall, wherein an inner area of the holder is open, wherein each central hinge receiving portion are disposed at each of both opposing sides of the holder and protrudes upwardly; a pivotable body having each central hinge protruding inwardly from both opposing inner side surfaces thereof, wherein each central hinge is pivotably received in each central hinge receiving portion of the vinyl bag holder; a cover covering all of the open portions of the housing, wherein the cover defines an inner space in which the pivotable body is accommodated, wherein the cover is partially opened; and a pet excrement disposal device detachably coupled to the pivotable body, wherein the pet excrement disposal device opens or closes the opened portion of the cover as the pivotable body pivots.

Further, a sealing device may be installed on a top surface of the bent portion of the partitioning wall.

Further, the vinyl bag holder may include: a lower holder installed in the portion of the open top of the housing not sealed with the partitioning wall; and an upper holder disposed on top of the lower holder and coupled to a top of the lower holder, wherein the lower and upper holders are capable of fixing the vinyl bag therebetween.

Further, each central hinge of the pivotable body may be pivotably connected to each central hinge receiving portion of the vinyl bag holder via a torsion spring.

Further, the pivotable body may include a guard having a curved outer circumferential surface to close the open portion as the pivotable body pivots.

Further, a portion of the guard through which the pet excrement disposal device is inserted may be open, wherein a portion of the guard opposite thereto through which the pet excrement of the guard passes may be open.

Further, in the one of the two spaces sealed with the partitioning wall, an upper protrusion may protrude from an inner surface of the bent portion of the partitioning wall, and a lower protrusion may protrude from an inner surface of a bottom of the housing facing the inner surface of the bent portion, wherein a vinyl bag roll is rotatably mounted to the upper and lower protrusions and is disposed therebetween.

Details of other embodiments are included in the detailed descriptions and drawings.

### Advantageous Effects

The pet excrement storage apparatus according to the embodiment of the present disclosure has one or more of following effects.

First, the apparatus neatly stores therein the pet excrement filtered by the excrement disposal device without spilling the same.

Second, the apparatus seals the odor of the stored pet excrement.

Third, the pet excrement disposal device may be mounted into the apparatus.

Effects of the present disclosure are not limited to the effects mentioned above, and other effects not mentioned will be clearly understood by those skilled in the art from the description of the claims.

### DESCRIPTION OF DRAWINGS

FIG. 1 is an exploded perspective view of a pet excrement storage apparatus according to an embodiment of the present disclosure.

FIG. 2 is a side cross-sectional view of a pet excrement storage apparatus according to an embodiment of the present disclosure.

FIG. 3 is a cross-sectional side view of a pet excrement storage apparatus in an open state according to an embodiment of the present disclosure.

FIG. 4 is a cross-sectional side view of a pet excrement storage apparatus in a closed state according to an embodiment of the present disclosure.

FIG. 5 is a photograph showing a use example of sealing a vinyl bag using a sealing device of a pet excrement storage apparatus according to an embodiment of the present disclosure.

### BEST MODE

Advantages and features of the present disclosure, and methods for achieving them will become clear with reference to embodiments as described later in detail in conjunction with the accompanying drawings. However, the present disclosure is not limited to the embodiments as disclosed below and may be implemented in various different forms. The present embodiments are set forth to make the present disclosure complete, and are provided to completely inform those skilled in the art of the scope of the present disclosure, and the present disclosure is only defined by the scope of the claims. Like reference numbers designate like elements throughout the specification.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers.

It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below.

### Mode

Hereinafter, a pet excrement storage apparatus according to an embodiment of the present disclosure will be described with reference to drawings.

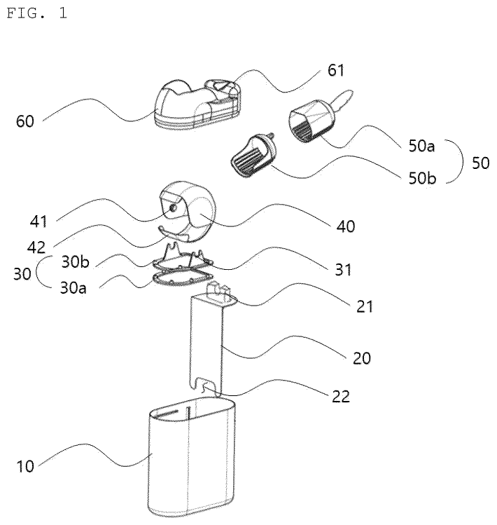

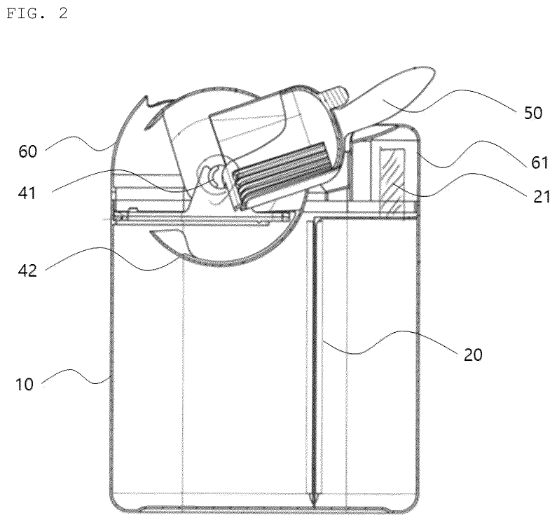

FIG. 1 is an exploded perspective view of a pet excrement storage apparatus according to an embodiment of the present disclosure, and FIG. 2 is a side cross-sectional view of the pet excrement storage apparatus according to an embodiment of the present disclosure.

Referring to FIG. 1 and FIG. 2, the pet excrement storage apparatus according to the embodiment of the present disclosure includes a housing 10, a partitioning wall 20, a vinyl bag holder 30, a pivotable body 40, a pet excrement disposal device 50, and a cover 60.

The housing 10 has an inner space defined therein to accommodate therein the pet excrement filtered by the pet excrement disposal device 50. An entirety of an upper surface of the housing 10 is open.

The partitioning wall 20 is installed in the inner space of the housing 10 and is formed in a plate shape extending in an elongated manner in a vertical direction to divide the inner space of the housing 10 into two spaces.

The partitioning wall 20 is formed such that an upper portion of the plate shape is bent at 90 degrees to seal one of the divided two inner spaces of the housing 10.

A protrusion capable of fixing a vinyl bag roll (not shown) protrudes from an inner surface of the bent portion of the partitioning wall 20.

The housing 10 has a protrusion protruding from a lower inner surface and at a position corresponding to the protrusion of the partitioning wall 20 capable of fixing the vinyl bag roll (not shown). The protrusion of the housing 10 may be capable of fixing the vinyl bag roll (not shown).

The vinyl bag roll (not shown) is pivotably disposed between the protrusion of the housing 10 and the protrusion of the partitioning wall 20.

A portion of a bottom of the plate shape of the partitioning wall 20 is opened to form a vinyl bag feeding hole 22, so that the vinyl bag of the vinyl bag roll (not shown) disposed in the sealed inner space of the housing 10 passes through the vinyl bag feeding hole 22 to the open inner space of the housing 10.

The vinyl bag holder 30 is installed to surround a portion of the open top of the housing 10 that is not sealed with the partitioning wall 20.

The vinyl bag holder 30 is formed so that an inner portion thereof is open.

A central hinge receiving portion 31 is formed on each of both opposing sides of the vinyl bag holder 30 and protrudes upwardly. Thus, each of both opposing central hinges 41 of the pivotable body 40 to be described later is pivotably received in each central hinge receiving portion 31.

The vinyl bag holder 30 includes a lower holder 30a installed to surround a portion of the open top of the housing 10 that is not sealed with the partitioning wall 20, and an upper holder 30b fixed to a top of the lower holder 30a.

The lower holder 30a and the upper holder 30b are detachably coupled to each other.

The vinyl bag of the vinyl bag roll (not shown) having passed through the vinyl bag feeding hole 22 may be fixedly disposed between the lower holder 30a and the upper holder 30b.

Each central hinge receiving portion 31 is formed on each of both opposing sides of the upper holder 30b of the vinyl bag holder 30 and protrudes upwardly. Thus, each of both opposing central hinges 41 of the pivotable body 40 to be described later is pivotably received in each central hinge receiving portion 31.

The pivotable body 40 is pivotally connected to the central hinge receiving portion 31.

Each of the central hinges 41 protrudes inwardly from each of both opposing inner sides of the pivotable body 40.

Each of the central hinges 41 of the pivotable body 40 is pivotably connected to each of the central hinge receiving portions 31 via a torsion spring (not shown) which is well-known. Thus, even when the pivotable body 40 pivots from the closed state to the open state under the external force from the user, the pivotable body 40 is restored to the closed state due to the torsion spring (not shown), when the external force is removed.

The pivotable body 40 includes a guard 42 having a curved outer circumferential surface to close the open portion of the housing 10 when the pivotable body 40 pivots.

A portion of the guard 42 through which the pet excrement disposal device 50 to be described later is inserted is opened. A portion thereof opposite thereto through which the pet excrement passes is opened.

The pet excrement disposal device 50 separates only the pet excrement from a mixture of the pet excrement and the sand.

The pet excrement disposal device 50 may be inserted through the portion opened in the guard 42 of the pivotable body 40.

The pet excrement disposal device 50 is inserted through the opened portion of the guard 42 of the pivotable body 40 to close the opened portion of the guard 42.

The cover 60 covers all of the open portions of the housing 10 and is detachably coupled to the housing 10.

The cover 60 defines an inner space in which the pivotable body 40 is accommodated.

A portion of the cover 60 is opened so that the pivotable body 40 is exposed to the outside.

The pet excrement disposal device 50 is inserted into the pivotable body 40 through the opened portion of the cover 60.

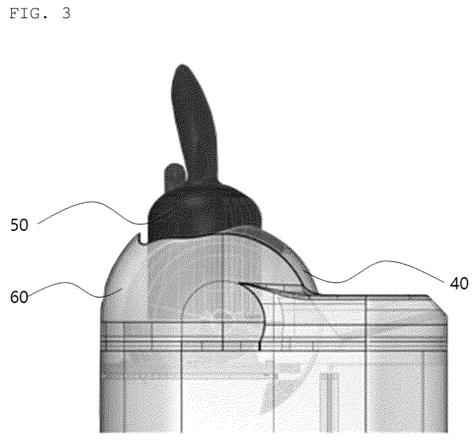

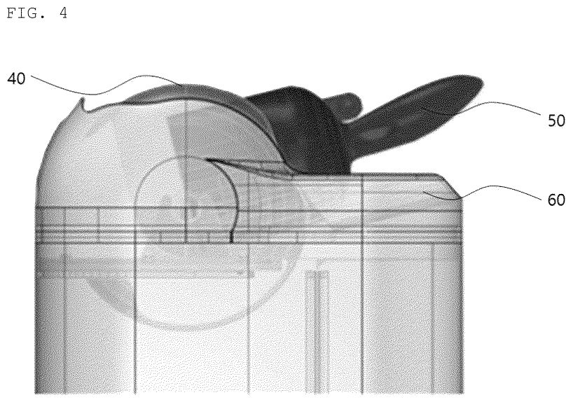

FIG. 3 is a side cross-sectional view of an open state of a pet excrement storage apparatus according to an embodiment of the present disclosure. FIG. 4 is a cross-sectional side view of a closed state of a pet excrement storage apparatus according to an embodiment of the present disclosure.

Referring to FIG. 3 and FIG. 4, the pet excrement disposal device 50 is inserted into the pivotable body 40 in the closed state. When the pivotable body 40 is pivoted to the open state under the external force applied from the user, the pet excrement stored in the pet excrement disposal device 50 falls down under the gravity and thus is received in the vinyl bag fixed to the holder 30.

When the excrement of the pet has been received in the vinyl bag and the external force applied from the user is removed, the pivotable body 40 is pivoted under the restoring force of the torsion spring (not shown) so as to be brought into the closed state. Thus, the portion of the pivotable body 40 opened due to the displacement of the pet excrement disposal device 50 inserted into the pivotable body 40 is closed to prevent the odor of the excrement of the pet from leaking out.

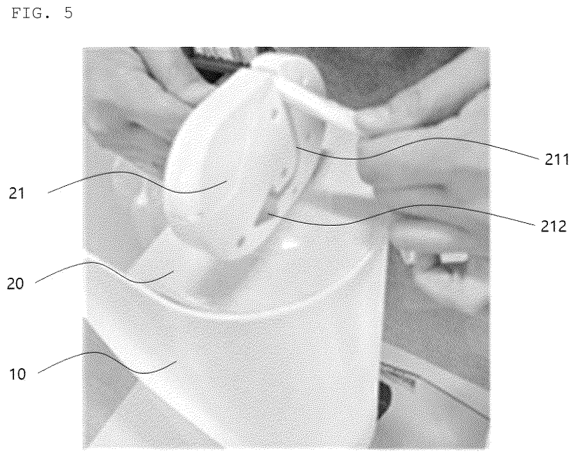

FIG. 5 is a photograph showing an example of sealing a vinyl bag using a sealing device of a pet excrement storage apparatus according to an embodiment of the present disclosure.

Referring to FIG. 1, FIG. 2 and FIG. 5, a sealing device 21 as a well-known component is disposed on a top surface of the bent portion of the partitioning wall 20 to seal the used vinyl bag.

The user of the pet excrement storage apparatus separates the cover 60 and the upper holder 30b from the apparatus when the amount of the pet excrement stored in the vinyl bag reaches a limit. Then, the user separates the vinyl bag from the pet excrement storage apparatus.

The user passes an inlet of the vinyl bag separated from the pet excrement storage apparatus through a sealing hole 211 of the sealing device 21 to seal the inlet of the vinyl bag, and then separates the sealed bag from the sealing device 21 through an outlet 212 communicating with the sealing hole 211.

After being sealed using the sealing device 21, the sealed vinyl bag is removed therefrom so that the odor of the pet excrement of the pet does not leak out.

Referring to FIG. 2, the cover 60 has a support 61 to support a handle portion of the pet excrement disposal device when the pet excrement storage apparatus is in a closed state.

The support 61 of the cover 60 defines a space inside to cover the sealing device so that the sealing device is not exposed to the outside, thereby increasing the diversity of design choices of the exposed portion.

### INDUSTRIAL APPLICABILITY

A person with ordinary knowledge in the technical field to which the present disclosure belongs will be able to understand that the present disclosure may be implemented in other specific forms without changing its technical spirit or essential characteristics. Therefore, it should be understood that the embodiments described above are not limiting but illustrative in all respects. The scope of the present disclosure is indicated by the scope of the claims to be described later rather than the detailed description above, and all changes or modifications derived from the meaning and scope of the claims and equivalent concepts thereof should be interpreted as being included in the scope of the present disclosure.

### REFERENCE NUMERALS

10: housing 20: partitioning wall
21: sealing device 22: vinyl bag feeding hole
30: vinyl bag holder 30a: lower holder
30b: upper holder 31: central hinge receiving portion
40: pivotable body 41: central hinge
42: guard 50: pet excrement disposal device
60: cover 61: support
211: sealing hole 212: outlet

1. A pet excrement storage apparatus comprising:
a housing having an inner space defined therein and having an open top;
a partitioning wall installed in the inner space of the housing and formed in a plate shape to divide the inner space into two spaces, wherein an upper portion of the plate shape is bent to seal a top of one of the two spaces, wherein a portion of a bottom of the plate shape is opened to form a vinyl bag feeding hole;
a vinyl bag holder installed to surround a portion of the open top of the housing not sealed with the partitioning wall, wherein an inner area of the holder is open, wherein each central hinge receiving portion are disposed at each of opposing sides of the holder and protrudes upwardly;
a pivotable body having each central hinge protruding inwardly from opposing inner side surfaces thereof, wherein each central hinge is pivotably received in each central hinge receiving portion of the vinyl bag holder;
a cover covering all of the open portions of the housing, wherein the cover defines an inner space in which the pivotable body is accommodated, wherein the cover is partially opened; and
a pet excrement disposal device detachably coupled to the pivotable body, wherein the pet excrement disposal device opens or closes the opened portion of the cover as the pivotable body pivots.

2. The apparatus of claim 1, wherein a sealing device is installed on a top surface of the bent portion of the partitioning wall.

3. The apparatus of claim 1, wherein the vinyl bag holder includes:
a lower holder installed in the portion of the open top of the housing not sealed with the partitioning wall; and
an upper holder disposed on top of the lower holder and coupled to a top of the lower holder, wherein the lower and upper holders are capable of fixing the vinyl bag therebetween.

4. The apparatus of claim 1, wherein each central hinge of the pivotable body is pivotably connected to each central hinge receiving portion of the vinyl bag holder via a torsion spring.

5. The apparatus of claim 1, wherein the pivotable body includes a guard having a curved outer circumferential surface to close the open portion as the pivotable body pivots.

6. The apparatus of claim 5, wherein a portion of the guard through which the pet excrement disposal device is inserted is open, wherein a portion of the guard opposite thereto through which the pet excrement of the guard passes is open.

7. The apparatus of claim 1, wherein in the one of the two spaces sealed with the partitioning wall, an upper protrusion protrudes from an inner surface of the bent portion of the partitioning wall, and a lower protrusion protrudes from an inner surface of a bottom of the housing facing the inner surface of the bent portion, wherein a vinyl bag roll is rotatably mounted to the upper and lower protrusions and is disposed therebetween.
